(19) United States
(12) Patent Application Publication
(10) Pub. No.: US 2013/0170987 A1
(43) Pub. Date: Jul. 4, 2013

(54) Wind Turbine Tower with Yaw Bearing System

(71) Applicants: Richard A. Himmelmann, Beloit, WI (US); Stephen E. Tongue, Hampden, MA (US)

(72) Inventors: Richard A. Himmelmann, Beloit, WI (US); Stephen E. Tongue, Hampden, MA (US)

(73) Assignee: Clipper Windpower, LLC, Carpinteria, CA (US)

(21) Appl. No.: 13/340,210

(22) Filed: Dec. 29, 2011

(51) Int. Cl. F03D 7/02; F16C 19/00; E04H 12/18; F16C 17/02

(52) U.S. Cl. 416/9; 384/129; 384/456; 52/114

(57) ABSTRACT

A wind turbine includes a vertically standing non-uniform tower adapted to support a horizontally oriented rotor. A fixed base portion of the turbine is adapted to support a separate rotatable tower having an upper rotor swept portion along the main body of the tower. The tower is adapted to be secured to the base for being rotatably yawed into the wind. A bearing system is housed between the base and lower tower extremity includes a pair of vertically spaced tracks situated on an annular support rail adapted to be fixed to a ground structure, for example a reinforced concrete foundation. The bearing system is further defined by pluralities of yaw bearing cartridge assemblies adapted to extend through flanged apertures of a skirt portion in the lower extremity of the tower.

### TECHNICAL FIELD

This disclosure relates to mechanical systems for enhancing operations of wind turbines. More particularly, the disclosure relates to a wind turbine tower that includes a yaw bearing system at the tower base adapted to permit the entire tower to rotate.

### BACKGROUND

The rotor blades of a utility scale wind turbine are ideally pitched toward or “yawed” into the wind. This orientation optimizes the amount of wind energy captured by the rotor, and in turn maximizes torque produced on a main shaft of the wind turbine to drive associated electric generators, for example.

Accordingly, the traditional wind turbine tower structure incorporates a rotor, a rotor shaft and bearings, collectively referred to as a turbine, along with a nacelle to support such structure. All are generally situated atop of a fixed tower, and are designed to rotate on the fixed tower structure for the purpose of maintaining the rotor in a position to always directly face the wind.

The typical tower has traditionally been constructed as a nonrotating vertically upstanding structure having a circular cross-section and generally adapted to accommodate wind forces in any given azimuthal direction. As such, traditional tower construction has tended to be relatively robust, requiring more physical material than towers that might otherwise employ, for example, aerodynamic configurations including airfoil and other non-uniform cross-sections adapted to rotate or yaw with the turbine and nacelle to face the wind. Such structures might require less robust configurations, utilizing reduced cross-sections to save construction material costs. Construction of such towers might require less strength and/or have reduced thickness in those circumferential portions or areas that are normal to the wind and/or otherwise not subject to direct wind forces.

A major limitation with respect to use of aerodynamic tower structures may have historically been related to difficulties of designing bearings adapted to accommodate the relatively high bending moments typically present near the bases of tower structures.

### SUMMARY OF THE DISCLOSURE

This disclosure proposes a wind turbine tower that incorporates a yaw bearing system at the base of the tower, rather than having the traditional yaw bearing situated atop of the tower.

In one aspect of the disclosure, a yaw track bearing system accommodates wind induced azimuthal rotation of the entire tower, along with the turbine and the nacelle, on a fixed annular rail that rotatably supports the tower.

Another aspect of the disclosure is the provision of a non-uniform tower structure, with at least an upper rotor swept tower portion having a relatively smaller cross-section in a direction normal to wind forces than that of a traditional tower.

In yet another aspect of the disclosure, a wind turbine base mounted bearing system incorporates a plurality of yaw bearing cartridge assemblies supported on spindles integral with conical wheels adapted to rotate at the tower base in annular tracks of a fixed support rail.

In a still further aspect of the disclosure, the tracks are vertically spaced by an amount marginally greater than the diameter of the conical wheels.

### BRIEF DESCRIPTION OF THE DRAWINGS

FIG. 1 is an elevational view of a wind turbine that embodies elements of the disclosure, depicting a tower that includes the disclosed yaw bearing system.

FIG. 2 is a cross-sectional view of a tower portion of the wind turbine, taken along lines 2-2 of FIG. 1.

FIG. 3 is an elevational view of a flared bottom portion of the same wind turbine, depicting a plurality of yaw bearing cartridge assemblies rotatably secured in the circumferentially extending bottom extremity of the tower.

FIG. 4 is a side view of one of the yaw bearing cartridge assemblies.

FIG. 5 is a cross-sectional view, taken along lines 5-5 of FIG. 3, of the lower tower extremity, depicting the manner in which one of the cartridge assemblies is rotatably secured via conical wheel and spindle to a tower base support rail.

### DETAILED DESCRIPTION

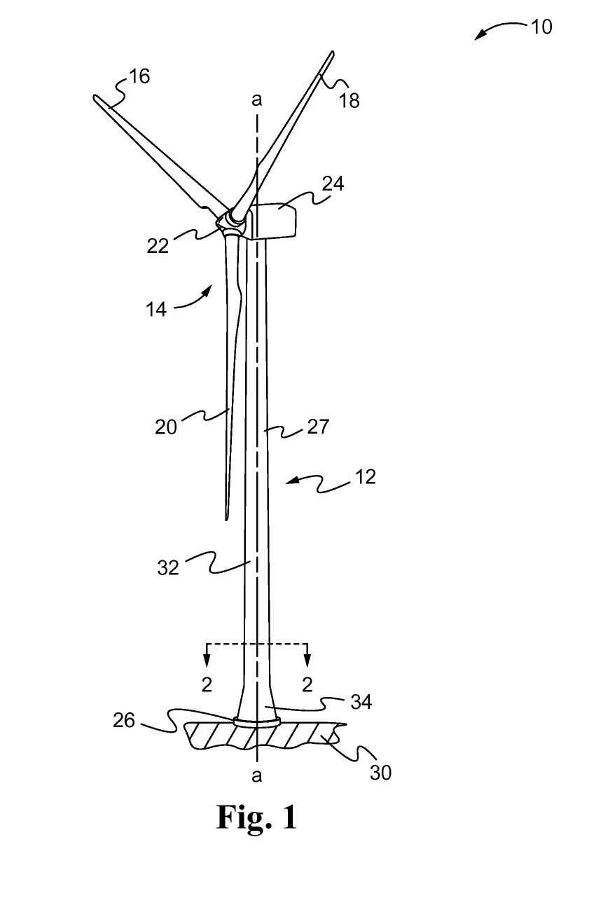

Referring initially to FIG. 1, a wind turbine 10 is constructed in accordance with at least one embodiment of the present disclosure. While all components of the wind turbine are not necessarily shown nor described herein, the wind turbine 10 may include an upstanding tower 12, having a vertical axis “a-a”, and supporting a rotor 14. The rotor may be defined by a plurality of circumferentially arrayed, equally spaced, rotatable blades 16, 18, and 20, along with a hub 22 to which each of the blades is radially connected.

The blades 16, 18, 20 (only three of which are employed in this example; there may be more or less) may be rotated by wind energy, such that the rotor 14 may transfer that energy via a main shaft (not shown) to one or more generators (not shown). Those skilled in the art will appreciate that such wind-power driven generators may produce commercial electric power for transmission to an electric grid (not shown). Those skilled in the art will also appreciate that a plurality of such wind turbines may be effectively employed on a so-called wind turbine farm to generate significant amounts of electric power. Although the disclosed embodiment focuses on wind only, this disclosure is pertinent to fluids generally, including other gases and even liquids, such as water, which may be used to drive similar turbine structures.

The tower 12 of this disclosure includes a nacelle 24 which houses a rotor main shaft (not shown) as well as supporting bearings (not shown). The nacelle 24 may also include at least one generator (also not shown) adapted to convert wind energy into electricity, as those skilled in the art will appreciate.

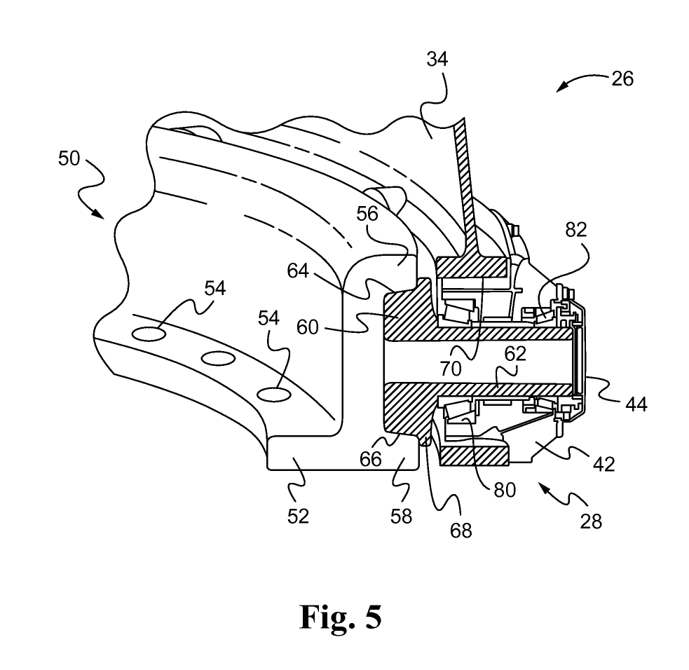

The tower 12 has an integral annular base 26 that may be rotatably secured to a support rail 50 (FIG. 5), as will be further described below. The rail 50 is adapted to be secured to foundation 30 or other fixed supporting structure, such as a reinforced concrete mass. The entire tower 12 is thus rotatable about such internally fixed support rail 50 (not shown in FIG. 1).

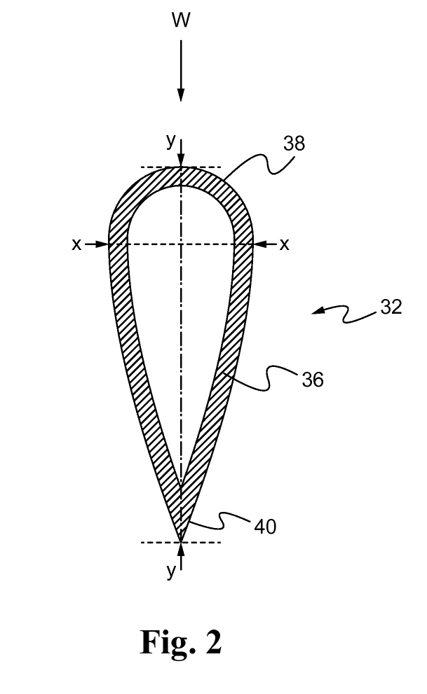

An upper portion of the main body 32 of the tower 12 is defined by a rotor swept portion 27. The rotor swept portion 27 of the tower 12 is herein defined as that tower area most adjacent to, and spaced immediately behind, the spinning rotor 14. For optimizing efficiency, main body 32 may have a non-uniform cross-section (FIG. 2) to accommodate any demanded azimuthal orientation of the tower 12, to the extent that the tower may in real time be rotatably, and hence angularly, yawed according to prevailing wind direction. Such non-uniform cross-sections may allow use of reduced amounts of materials for construction. For example, the use of an airfoil shape has been demonstrated to permit employment of smaller tower cross-sections in a direction normal to the wind.

Continuing reference to FIG. 1, the tower 12 has a cone shaped or flared bottom portion 34 situated immediately above its base 26 to accommodate transition from the non-uniform cross-section 36 (FIG. 2) of its upper main body 32 to a circular cross-section at its base 26.

Referring now specifically to FIG. 2, the non-uniform cross-section 36 of the main body 32 of the tower 12 is depicted as having an aerodynamic or airfoil shape, as shown. The aerodynamic shape has a minor axis XX situated orthogonally to wind direction, arrow W, and a major axis YY situated parallel with the wind. The major axis YY has a greater dimension than the orthogonal-to-the-wind minor axis XX. As earlier noted, the use of non-uniform, including aerodynamic, shapes may require use of less tower construction materials, and thus may result in reduced construction costs.

As shown, those skilled in the art will appreciate that the prevailing wind W is ideally always directed toward the leading edge 38 of the main body 32 of the tower 12. Accordingly, the trailing edge 40 will optimally be positioned downwind to assure wind turbine operating efficiency.

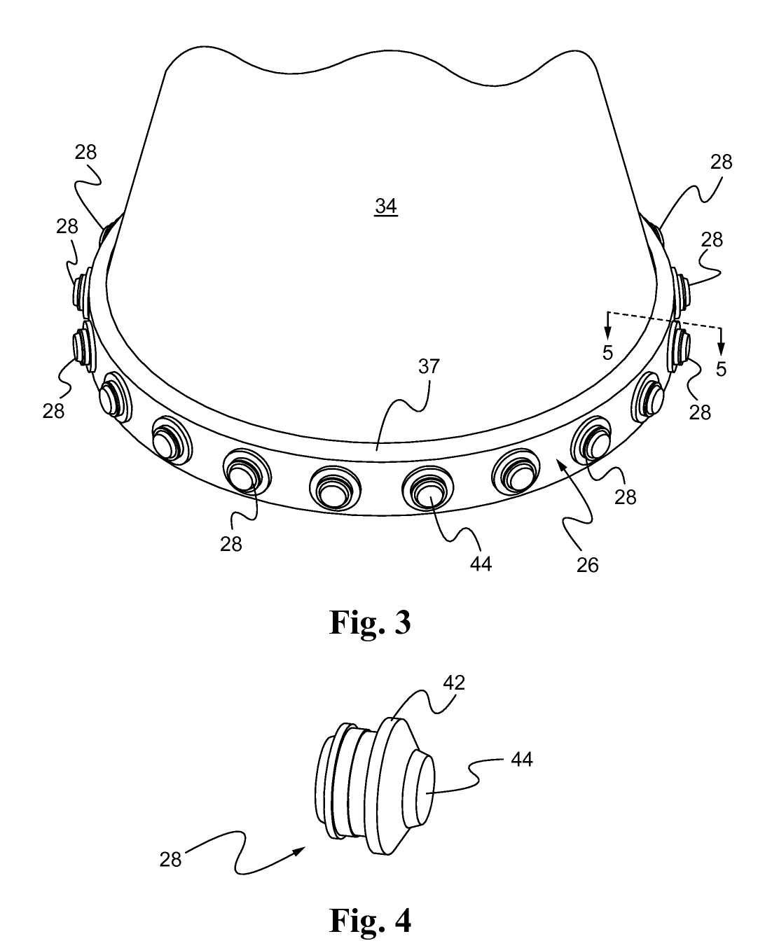

FIG. 3 depicts the flared bottom 34 of the tower 12 as terminating at a radially extending stepped interface 37 with the circular tower base 26. As shown, the base 26 may have a relatively thicker wall structure than other portions of the tower 12, thus providing for enhanced structural support. A plurality of yaw bearing cartridge assemblies 28 may be retained circumferentially about and within the base 26 as shown, for the rotatable support of the tower as earlier noted.

Referring now also to FIG. 4, it will be appreciated that each yaw bearing cartridge assembly 28 includes an exterior housing 42 and a bearing cap 44 for reasons that will be made apparent below.

Referring now specifically to FIG. 5, the earlier noted support rail 50 contains an interior bottom flange 52 adapted to be secured to a fixed foundation 30 (FIG. 1). As such, the bottom flange 52 includes securement apertures 54 to accommodate bolts (not shown) for securing the support rail to the foundation 30. Radially outer tracks extend from the support rail 50, to comprise an upper track 56 and a lower track 58. The tracks are adapted to accommodate respective top and bottom surfaces 64 and 66 of rolling conical wheels 60. The wheels 60 have integral spindles 62, and each spindle is carried within one of the yaw bearing cartridge assemblies 28, as depicted. Although the particular spindle 62 is shown to have a hollow cross-section, the spindle could alternatively have a solid cross-section, depending on particular sizing and tower load requirements, etc. A hollow structure may be easier to fabricate, while a solid structure may present an opportunity for use of an even smaller cross-section.

Those skilled in the art will appreciate that each conical wheel 60 is adapted to engage and roll within the pair of respective upper and lower tracks 56, 58 by means of an upper conical rolling contact surface 64 (which may interface with the upper track 56) and a lower track conical rolling contact surface 66 (which may interface with the lower track 58). For the respective conical rolling contact surfaces 64 and 66 to satisfactorily engage the tracks 56, 58, it may be appreciated that the tracks may be flared slightly angularly in a radially outward direction, such that, as viewed in FIG. 5, the track 58 angles slightly downwardly, while the track 56 angles slightly upwardly. In addition, the tracks 56, 58 should be spaced a marginally greater distance apart than any given diameter of the conical wheel 60 at the point of engagement or contact. This expedient will facilitate proper operation of the rotatable tower even under high wind conditions wherein the tower may be cocked, i.e. one side of the tower may be lifted or raised relative to the opposite side of the tower, as may be appreciated by those skilled in the art.

The base 26 of the tower 12 is constructed in the nature of a downwardly depending annular skirt that may be flanged, or otherwise have a thicker construction than other portions of the tower, as previously noted. Thus, the aperture 70 is depicted to be considerably thicker than the adjoining wall of the flared tower bottom 34. As such, each aperture 70 may be effective to securely retain one yaw bearing cartridge assembly 28.

Each bearing cartridge 28 contains radially inner rollers 80 and radially outer rollers 82, as shown. Although depicted as roller bearings, other types of bearings may be employed, including spherical, thrust, conical, and even plain bearings (bushings).

The plurality of cartridge assemblies 28 collectively carries the weight of the entire tower 12 on the spindles 62 for providing relative rotation about the annular support rail 50, as has been shown and described.

Although only conical wheels in mating tracks have been described in reference to the embodiment as shown and described herein, the use of round rails with concave wheels (similar to that employed in roller coasters), or flat rails with cylindrical wheels, or even concave rails with convex wheels, constitute just a few of numerous alternative approaches that may fall within the spirit and scope of this invention.

In addition, the support rail could be positioned outside of the circular tower base 26, with the bearing cartridges inserted from inside of the tower, and extending radially outwardly of the tower (opposite of that as shown and described in this embodiment).

Further, the bearing cartridges could alternatively be mounted to the fixed inner (or outer) fixed ring, with the rail mounted to the rotating tower as an alternative to the structure shown and described herein.

Further, the described embodiment has the integral spindle; those skilled in the art will appreciate that the conical wheel could alternatively be attached to a separate axle.

Finally, the described embodiment uses only one set of wheels in conjunction with an upper and lower rail. With some modification of structure, a single rail could be used, with a pair of wheel assemblies engaging opposed sides of the rail; i.e. with one wheel assembly above the rail and one wheel assembly below the rail.

Numerous other expedients will be recognized by those skilled in the art to fall within the spirit and scope of this invention.

### INDUSTRIAL APPLICABILITY

The present disclosure generally sets forth a yaw bearing system that may enhance the utility of wind towers by making them more cost efficient. A reduction in capital costs, due to reduction in raw material usage required to fabricate a wind turbine tower, may be achieved by designing the tower to be rotatable, and to incorporate an aerodynamic or otherwise non-uniform tower cross-section requiring less materials than would a standard traditional circular cross-section.

The disclosure offers an improved wind turbine tower that incorporates a yaw bearing system at the tower base, rather than a single yaw bearing for turbine and nacelle structures at the top of the tower. Replacement of the traditional single yaw bearing in this manner supports rotation of the entire tower structure, thus permitting the wind turbine, nacelle structures, and the tower to rotate as a unit about an annular dual track base support rail. In such a manner, azimuthal wind alignment of the tower with nacelle and turbine structures can be always assured, while permitting the tower to be constructed with smaller cross-sections in directions normal to the wind forces.

Current wind turbine structures require having to disassemble the turbine and to remove the entire nacelle in order to replace a worn-out yaw bearing atop of the tower. The tower base-level bearing structure of this disclosure offers at least the particular advantages of (a) avoiding safety dangers inherent in having to change bearings at high elevations, and (b) individual removal and replacement of bearing cartridge assemblies without need for disassembly of the turbine and/or removal of the nacelle as required in current wind turbine structures. Moreover, the costs associated with use of small bearings are relatively low as compared to costs of using the large yaw bearings of current wind turbines.

The result is a relatively robust bearing system adapted to accommodate a) significant non-uniform wind forces on the yawing tower structure, while b) using a non-uniform, e.g. aerodynamic, cross-section in the main body of the tower to reduce costs of manufacture.

We claim:

1. A wind turbine comprising:
a base including at least one circumferentially extending track, the base adapted to be fixed relative to the ground;
a tower having a vertical axis and an elongated upper main body, the tower adapted for rotation about the axis, and having a bottom extremity defining a circumferentially extending skirt portion adapted to be rotatably anchored to the track for accommodating wind induced rotatable yaw movement of the tower,
a plurality of circumferentially disposed conical wheels positioned in rotary engagement with the track, each wheel having at least one radially extending spindle; and
a corresponding plurality of circumferentially disposed yaw bearing cartridge assemblies affixed to the skirt portion, each cartridge assembly rotatably mounted on one spindle to collectively support the rotatable movement of the tower about the base.

2. The wind turbine of claim 1, wherein the tower is adapted to support a horizontally oriented rotor at its top end.

3. The wind turbine of claim 1, wherein the main body of the tower includes at least an upper vertically extending rotor swept portion having an non-uniform cross-section and a lower extremity having a circular cross-section, wherein a conical transition zone is defined along the vertical axis of the tower, said zone extending between the two diverging cross-sections.

4. The wind turbine of claim 1, wherein the skirt is flanged, and the plurality of circumferentially spaced apertures extend radially through the skirt, the apertures being adapted to support the affixed plurality of yaw bearing cartridge assemblies.

5. The wind turbine of claim 3, wherein the rotor swept portion of the tower comprises a non-uniform cross-section having major and minor axes, and wherein the minor axis is adapted to be orthogonally positioned relative to wind direction.

6. The wind turbine of claim 5, wherein the minor axis is shorter than the major axis, and wherein the width of the rotor swept tower portion comprises a thinner dimension thereof in a direction orthogonal to the wind.

7. The wind turbine of claim 1, wherein the circumferentially extending track defines an annular support rail positioned radially inwardly of the skirt portion, and wherein the skirt portion is aligned concentrically with the track.

8. The wind turbine of claim 7, wherein the support rail further comprises a pair of spaced upper and lower outer circumferentially extending tracks.

9. The wind turbine of claim 8, wherein each of the plurality of conical wheels is adapted for rotation within and between the upper and lower tracks.

10. The wind turbine of claim 9, wherein the pair of tracks are vertically spaced a distance marginally greater than the diameter of any one of the conical wheels.

11. A non-uniform tower for a wind turbine, the tower having a vertical axis and being adapted to support a horizontally oriented rotor, the tower adapted for rotation about the axis, the tower comprising:
a base including at least one circumferentially extending track, the base adapted to be fixed relative to the ground;
an elongated upper main body, and a bottom extremity defining a circumferentially extending skirt portion adapted to be rotatably anchored to the track for accommodating wind induced rotatable yaw movement of the tower,
a plurality of circumferentially disposed conical wheels positioned in rotary engagement with the track, each wheel having at least one radially extending spindle; and
a corresponding plurality of circumferentially disposed yaw bearing cartridge assemblies affixed to the skirt portion, each cartridge assembly rotatably mounted on one spindle to collectively support the rotatable movement of the tower about the base.

12. The non-uniform tower of claim 11, further including the upper main body having a vertically extending rotor swept portion with a non-uniform cross-section and a lower extremity having a circular cross-section, wherein a conical transition zone is defined along the vertical axis of the tower, said zone extending between the two diverging cross-sections.

13. The non-uniform tower of claim 11, wherein the skirt is flanged, and the plurality of circumferentially spaced apertures extend radially through the skirt, the apertures being adapted to support the affixed plurality of yaw bearing cartridge assemblies.

14. The non-uniform tower of claim 12, wherein the rotor swept portion of the tower comprises a non-uniform cross-section having major and minor axes, and wherein the minor axis is adapted to be orthogonally positioned relative to wind direction.

15. The non-uniform tower of claim 14, wherein the minor axis is shorter than the major axis, and wherein the width of the upper tower portion comprises a thinner dimension thereof in a direction orthogonal to the wind.

16. The non-uniform tower of claim 11, wherein the circumferentially extending track defines an annular support rail positioned radially inwardly of the skirt portion, and wherein the skirt portion is aligned concentrically with the track.

17. The non-uniform tower of claim 11, wherein the support rail further comprises a pair of spaced upper and lower outer circumferentially extending tracks, and wherein each of the plurality of conical wheels is adapted for rotation within and between the upper and lower tracks.

18. The non-uniform tower of claim 11, wherein the pair of tracks are vertically spaced a distance marginally greater than the diameter of any one of the conical wheels.

19. A rotary track bearing system for a non-uniform wind turbine, comprising:
a base including at least one circumferentially extending track, the base adapted to be fixed relative to the ground;
a tower having a vertical axis and an elongated upper main body, the tower adapted for rotation about the axis, and a bottom extremity defining a circumferentially extending skirt portion adapted to be rotatably anchored to the track for accommodating wind induced rotatable yaw movement of the tower;
a plurality of circumferentially disposed conical wheels positioned in rotary engagement with the track, each wheel having at least one radially extending spindle; and
a corresponding plurality of circumferentially disposed yaw bearing cartridge assemblies affixed to the skirt portion, each cartridge assembly rotatably mounted on one spindle to collectively support the rotatable movement of the tower about the base.

20. The bearing system of claim 19, wherein the main body of the tower includes at least an upper vertically extending rotor swept portion having a non-uniform cross-section and a lower extremity having a circular cross-section, wherein a conical transition zone is defined along the vertical axis of the tower, said zone extending between the two diverging cross-sections.
